(19) United States
(12) Patent Application Publication
(10) Pub. No.: US 2017/0222239 A1
(43) Pub. Date: Aug. 3, 2017

(54) FUEL MIXING APPARATUS, FUEL CELL SYSTEM, AND FUEL MIXING-AND-TRANSMITTING METHOD

(71) Applicant: CHUNG-HSIN ELECTRIC & MACHINERY MFG. CORPORATION, Taoyuan City (TW)

(72) Inventors: Wen-Shih CHANG, Taoyuan City (TW); Huan Chun TSENG, Taoyuan City (TW); Harol KOYAMA, Bend, OR (US)

(21) Appl. No.: 15/137,878

(22) Filed: Apr. 25, 2016

(30) Foreign Application Priority Data
Jan. 30, 2016 (TW) 105103012

(51) Int. Cl. H01M 8/0606; B01F 15/00; H01M 8/04082; B01F 15/02; H01M 8/0612; H01M 8/04089

(52) U.S. Cl. CPC H01M 8/0606; H01M 8/0618; H01M 8/04089; H01M 8/04201; B01F 15/0243; B01F 15/026; B01F 15/00175; B01F 15/00155; B01F 15/0035; B01F 2215/0088

(57) ABSTRACT

A fuel mixing apparatus for fuel cell system includes a first fluid tank, a second fluid tank, a tube assembly, a pump, and a mixing tank. The first fluid tank is for containing a first fluid. The second fluid tank is for containing a second fluid. The tube assembly connects to the first fluid tank and the second fluid tank. The pump is disposed on the tube assembly. The mixing tank is connected to the tube assembly. The pump transmits the first fluid in the first fluid tank to the mixing tank via the tube assembly, and the pump transmits the second fluid tank to the mixing tank via the tube assembly.

### CROSS-REFERENCE TO RELATED APPLICATIONS

This Application claims priority of Taiwan Patent Application No. 105103012 filed on Jan. 30, 2016, the entirety of which is incorporated by reference herein.

### BACKGROUND OF THE INVENTION

Field of the Invention

The present disclosure relates to a fuel mixing apparatus and a fuel mixing-and-transmitting method, and in particular to a fuel mixing apparatus and a fuel mixing-and-transmitting method for a fuel cell system.

Description of the Related Art

A large-scale fuel cell system can be a standby power source for an apparatus, such as a cell site. When the primary power source for the cell site is off, the fuel cell system starts up to supply power to the cell site, for maintaining the operation of the cell site.

However, the fuel of the fuel cell system is consumed and needs to be refilled after the fuel cell system is started up. Therefore, the maintenance cost of the fuel cell system depends on the volume of fuel and the number of times it takes to refill fuel in the fuel cell system.

Although existing fuel cell systems have been generally adequate for their intended purposes, they have not been entirely satisfactory in all respects. Consequently, it would be desirable to provide a solution for improving the fuel cell system.

### BRIEF SUMMARY OF THE INVENTION

The present disclosure provides a fuel mixing apparatus, a fuel cell system, and a fuel mixing-and-transmitting method for fuel cell system. The number of times of refilling fuel of the fuel cell system is decreased, and the maintenance cost of the fuel cell system is decreased by mixing the fuel in the fuel cell system.

The present disclosure provides a fuel mixing apparatus for fuel cell system, including a first fluid tank, a second fluid tank, a tube assembly, a pump, and a mixing tank. The first fluid tank is configured to contain a first fluid. The second fluid tank is configured to contain a second fluid. The tube assembly is connected to the first fluid tank and the second fluid tank. The pump is mounted on tube assembly. The mixing tank is connected to the tube assembly. The pump transmits the first fluid in the first fluid tank to the mixing tank via the tube assembly, and the pump transmits the second fluid in the second fluid tank to the mixing tank via the tube assembly. The first fluid and the second fluid are mixed to be a fuel in the mixing tank.

The present disclosure provides a fuel cell system, including the fuel mixing apparatus, further including a fuel cell stack coupled to the fuel mixing apparatus, and configured to generate electric power.

The present disclosure provides a fuel mixing-and-transmitting method for a fuel cell system, including detecting the height of the liquid level of the fuel in a mixing tank; transmitting a first fluid in a first fluid tank to a mixing tank via a tube assembly by a pump, when the height of the liquid level is equal to or lower than the height of the replenishing-liquid level; transmitting a second fluid in a second fluid tank to the mixing tank via the tube assembly and by the pump, wherein the first fluid and the second fluid are mixed to be a fuel in the mixing tank.

In conclusion, since the first fluid tank contains the first fluid, and the second fluid tank contains the second fluid, the first fluid needs to be refilled into the first fluid tank until the first fluid is insufficient. Therefore, the number of times required for refilling the fuel to the fuel cell system is decreased. Moreover, the fuel is formed by automatically mixing the first fluid and the second fluid in the fuel cell system. Therefore, the maintenance cost of the fuel cell system is decreased.

Moreover, the present disclosure utilizes only one pump to individually transmit the first fluid in the first fluid tank and the second fluid in the second fluid tank to the mixing tank. Therefore, the maintenance cost of the fuel mixing apparatus is further decreased.

### BRIEF DESCRIPTION OF THE DRAWINGS

The invention can be more fully understood by reading the subsequent detailed description and examples with references made to the accompanying drawings, wherein:

FIG. 1 is a system diagram of a fuel cell system in accordance with some embodiments of the present disclosure.

FIG. 2 is a system diagram of the fuel mixing apparatus in accordance with a first embodiment of the present disclosure.

FIGS. 3A to 3D are system diagrams of the fuel mixing apparatus during stages of fuel mixing-and-transmitting method in accordance with the first embodiment of the present disclosure.

FIG. 4 is a flow chart of the fuel mixing-and-transmitting method for the fuel cell system in accordance with some embodiments of the present disclosure.

FIG. 5 is a system diagram of the fuel mixing apparatus in accordance with a second embodiment of the present disclosure.

FIG. 6 is a system diagram of the fuel mixing apparatus in accordance with a third embodiment of the present disclosure.

### DETAILED DESCRIPTION OF THE INVENTION

The present disclosure may repeat reference numerals and/or letters in the various examples. This repetition is for the purpose of simplicity and clarity and does not in itself dictate a relationship between the various embodiments and/or configurations discussed.

It should be understood that additional operations can be provided before, during, and after the method, and some of the operations described can be replaced or eliminated for other embodiments of the method.

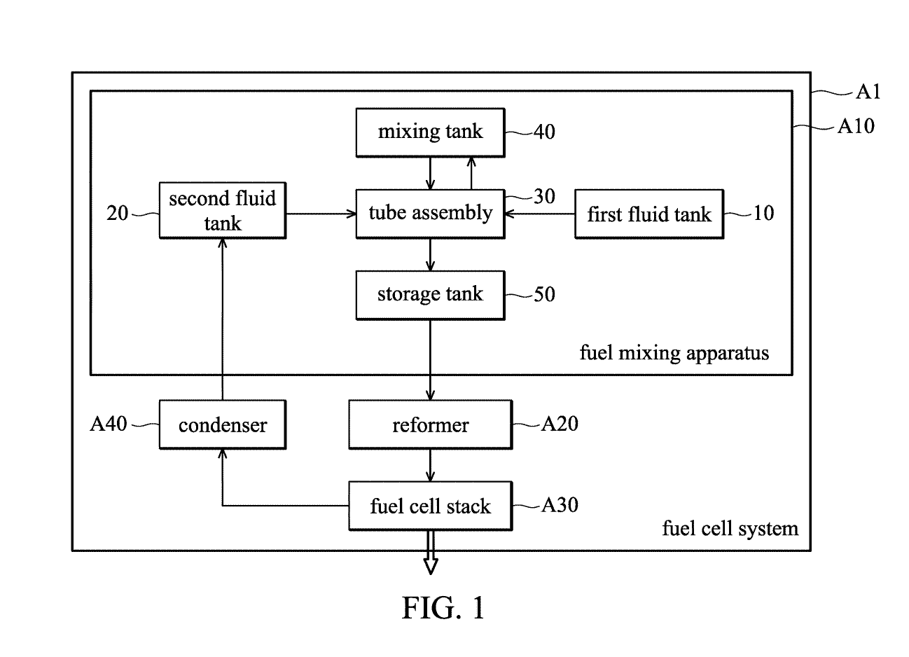

FIG. 1 is a system diagram of a fuel cell system A1 in accordance with some embodiments of the present disclosure. The fuel cell system A1 is configured to generate electric power. The fuel cell system A1 includes a fuel mixing apparatus A10, a reformer A20, a fuel cell stack A30, and a condenser A40. The fuel mixing apparatus A10 is configured to mix a first fluid and a second fluid to be a fuel depending on a predetermined weight ratio, and configured to transmit the fuel to reformer A20.

In this embodiment, the first fluid is methanol, and the second fluid is water or DI water. The predetermined weight ratio of the first fluid and the second fluid is in a range from about 64:36 to 58:42.

The reformer A20 is coupled to the fuel mixing apparatus A10, and configured to receive the fuel from the fuel mixing apparatus A10. Moreover, the reformer A20 reforms the fuel, and transmits the fuel to the fuel cell stack A30.

In this embodiment, the fuel transmitted to the reformer A20 by the fuel mixing apparatus A10 is liquid fuel, and the liquid fuel is reformed to be a gas fuel by the reformer A20. In this embodiment, the liquid fuel is a methanol solution, and the gas fuel is hydrogen.

The fuel cell stack A30 is coupled to the reformer A20. The fuel cell stack A30 is configured to receive the fuel from the reformer A20, and generate electric power. In this embodiment, the fuel cell stack A30 receives the air outside the fuel cell system A1 and the hydrogen (the gas fuel), and react the air and the hydrogen to generate electric power, heat, and water (or the second fluid).

In some embodiments, the fuel cell system A1 does not include reformer A20, and the fuel mixing apparatus A10 is coupled to the fuel cell stack A30. In other words, the fuel cell stack A30 is configured to receive the fuel from the fuel mixing apparatus A10, and generate electric power.

In some embodiments, the components of the first fluid and the second fluid are not limited in the present disclosure. The components of the first fluid and the second fluid is accepted if the fuel applied to the fuel cell stack A30 makes the fuel cell stack A30 generate electric power (the fuel generated by reformer A20 after the first fluid and the second fluid are mixed, or the fuel is formed by the mixture of the first fluid and the second).

The condenser A40 is coupled to the fuel cell stack A30 and the second fluid tank 20 of the fuel mixing apparatus A10. The condenser A40 gathers the water (or the second fluid) generated by fuel cell stack A30, and transmits the water (or the second fluid) to the second fluid tank 20. Therefore, the water (or the second fluid) generated by the fuel cell stack A30 can be recycled, and the water (or second fluid) requirement of the fuel cell system A1 is decreased.

Moreover, since the water (or second fluid) generated by the fuel cell stack A30 can be recycled, or replenished in the local place of the fuel cell system A1, the water requirement (or the second fluid requirement) of the fuel cell system A1 of the present disclosure is low, and the quantity of water (or second fluid) transported to the fuel cell system A1 from other places is greatly decreased. When replenishing the fuel cell system A1, the first fluid is the major replenish fluid for the fuel cell system A1. Therefore, the quantity of fuel or the number of times required to refill the fuel cell system is greatly decreased, and the maintenance cost of the fuel cell system is decreased. Moreover, the volume of the first fluid tank 10 can be increased to increase the interval time of replenishing the fuel cell system A1.

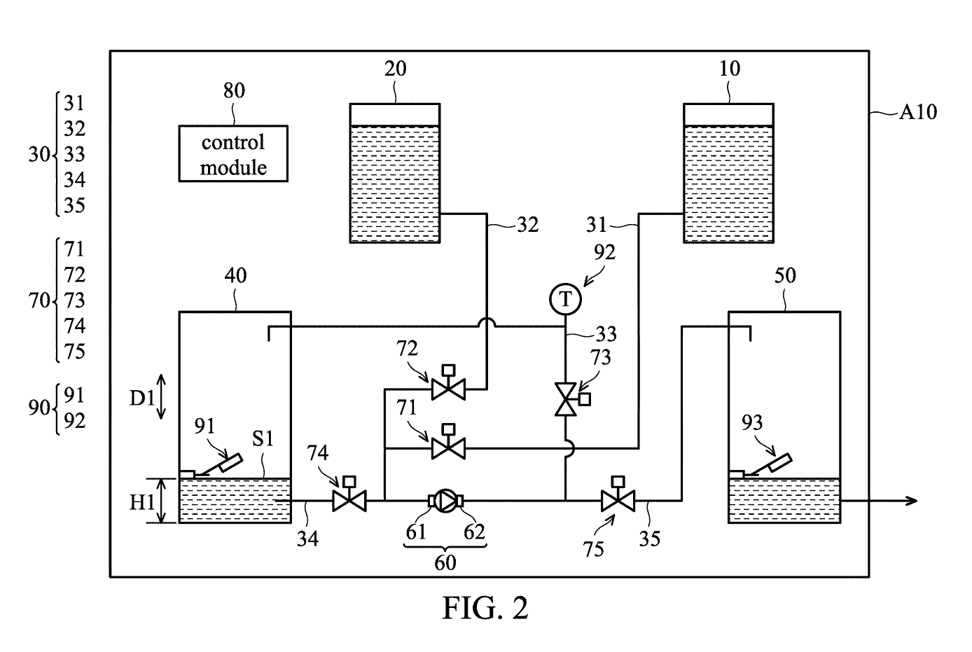

FIG. 2 is a system diagram of the fuel mixing apparatus A10 in accordance with a first embodiment of the present disclosure. The fuel mixing apparatus A10 further includes a first fluid tank 10, a second fluid tank 20, a tube assembly 30, a mixing tank 40, a storage tank 50, a pump 60, control valves 70, a control module 80, and a detection module 90.

The first fluid tank 10 is configured to receive the first fluid, and the second fluid tank 20 is configured to receive the second fluid. The tube assembly 30 is connected to the first fluid tank 10 and the second fluid tank 20.

The mixing tank 40 is connected to the tube assembly 30, and configured to receive the first fluid, the second fluid and/or the fuel via the tube assembly 30. The first fluid and the second fluid are mixed in the mixing tank 40 to be the fuel. The storage tank 50 is connected to the tube assembly 30, and configured to receive the fuel in the mixing tank 40 via the tube assembly 30.

The pump 60 is mounted on the tube assembly 30. In this embodiment, the pump 60 is a quantitative pump. The control valves 70 are mounted on the tube assembly 30, and configured to allow or block the first fluid, the second fluid or the fuel to pass through the control valves 70. The control module 80 is electrically connected to the pump 60 and the control valves 70.

The control module 80 respectively controls the control valves 70 and the pump 60 to turn on or off. Therefore, the pump 60 can selectively transmit the first fluid to the mixing tank 40, the second fluid to the mixing tank 40, or the fuel to the storage tank 50 via the mixing tank 40.

In this embodiment, the pump 60 includes an inlet 61 and an outlet 62. The pump 60 draws the first fluid, the second fluid or the fuel via the inlet 61, and exhausts the first fluid, the second fluid or fuel via the outlet 62.

In this embodiment, the tube assembly 30 further includes a first pipe 31, a second pipe 32, a third pipe 33, a fourth pipe 34, and a fifth pipe 35. The first pipe 31 is connected to the first fluid tank 10 and the inlet 64 of the pump 60. The second pipe 32 is connected to the second fluid tank 20 and the inlet 64 of the pump 60. The third pipe 33 is connected to the outlet 62 of the pump 60 and the mixing tank 40. The fourth pipe 34 is connected to the mixing tank 40 and the inlet 64 of the pump 60. The fifth pipe 35 is connected to the outlet 62 of the pump 60 and the storage tank 50.

Portions of the first pipe 31, the second pipe 32, the third pipe 33, the fourth pipe 34, and the fifth pipe 35 can be overlapped. In this embodiment, the portions of first pipe 31, the second pipe 32, and the fourth pipe 34 close to the inlet 61 are overlapped. The portions of the third pipe 33 and the fifth pipe 35 close to the outlet 62 are overlapped.

In this embodiment, the control valves 70 further include a first control valve 71, a second control valve 72, a third control valve 73, a fourth control valve 74, and a fifth control valve 75. The first control valve 71 is mounted on the first pipe 31, the second control valve 72 is mounted on second pipe 32, the third control valve 73 is mounted on the third pipe 33, the fourth control valve 74 is mounted on the fourth pipe 34, and the fifth control valve 75 is mounted on the fifth pipe 35.

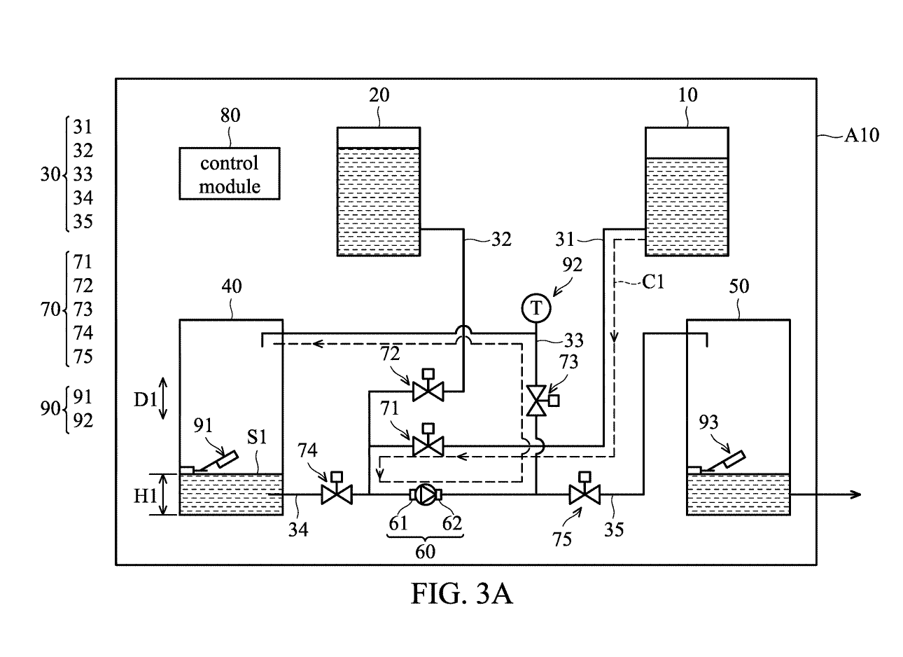

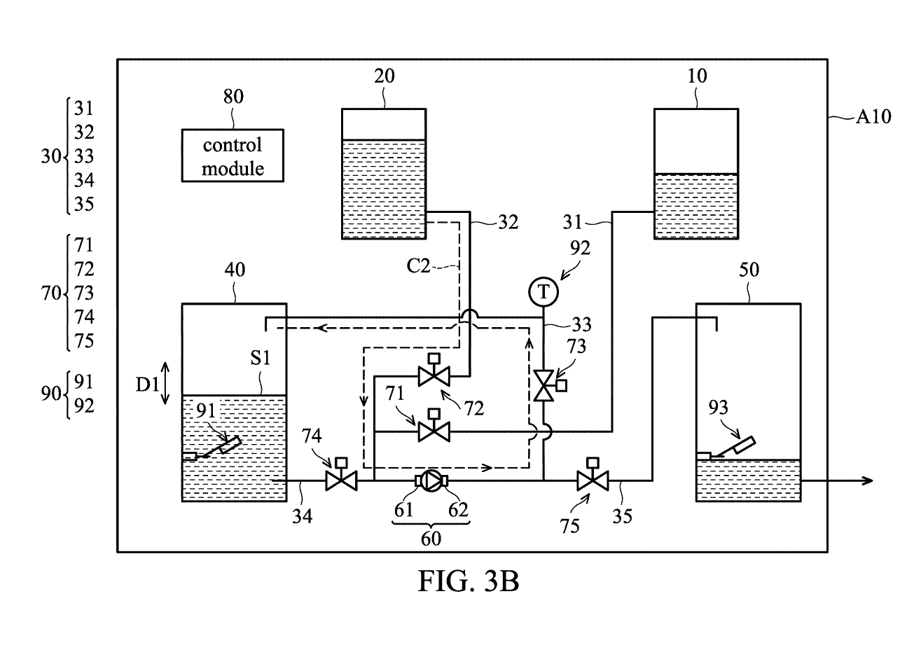

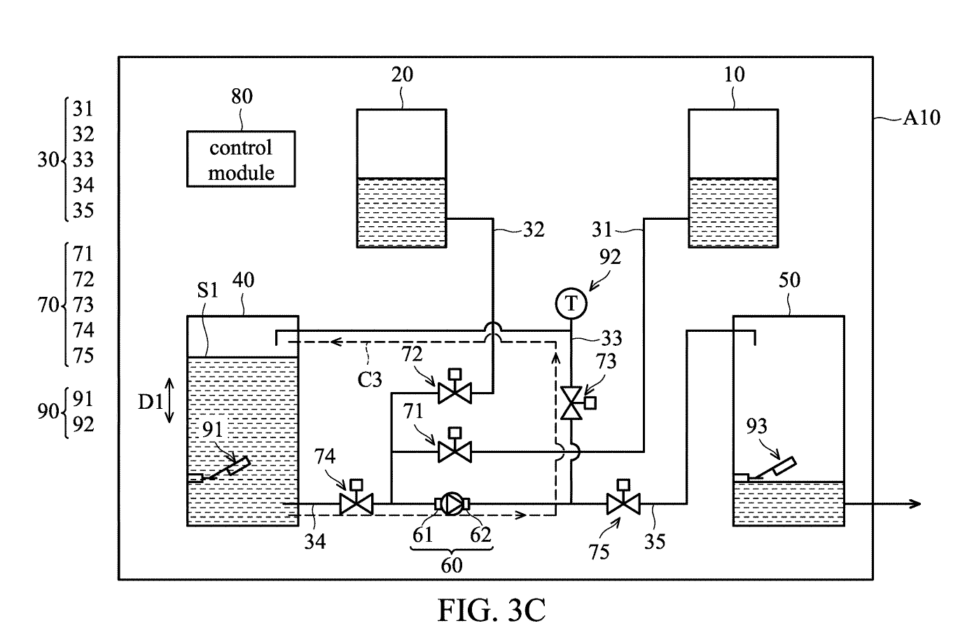

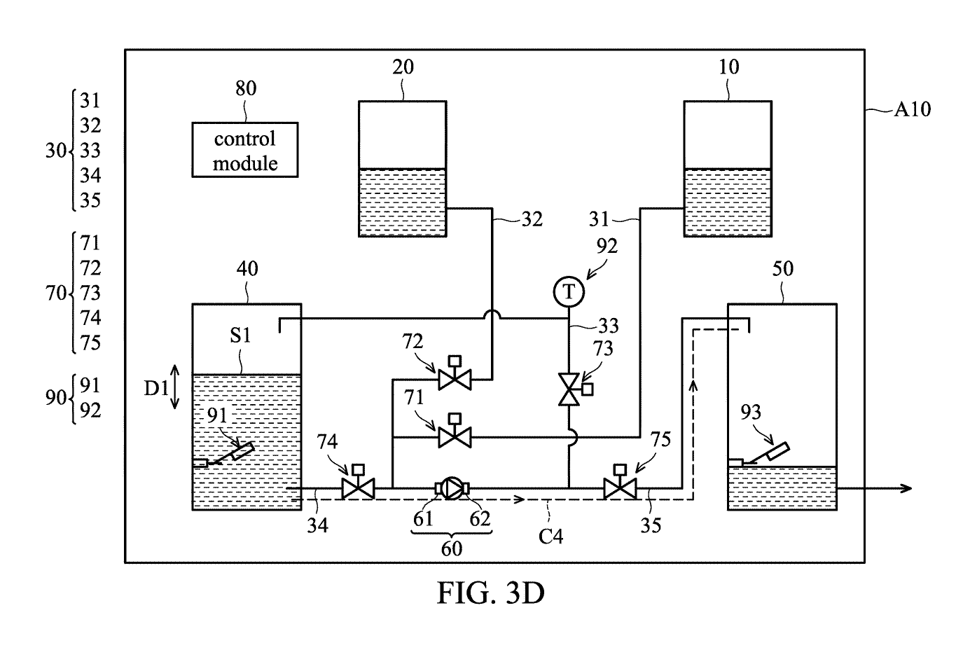

FIGS. 3A to 3D are system diagrams of the fuel mixing apparatus A10 during stages of fuel mixing-and-transmitting method in accordance with the first embodiment of the present disclosure. As shown in FIG. 3A, the control module 80 turns on the first control valve 71 and the third control valve 73, and turns off the second control valve 72, the fourth control valve 74, and the fifth control valve 75, and thus a flow path C1 between the first fluid tank 10 and the mixing tank 40 is formed in the tube assembly 30. Therefore, the control module 80 can turn on the pump 60 and control the pump 60 to transmit the first fluid in the first fluid tank 10 to the mixing tank 40 via the flow path C1.

As shown in FIG. 3B, the control module 80 turns on the second control valve 72 and the third control valve 73, and turns off the first control valve 71, the fourth control valve 74, and the fifth control valve 75, and thus a flow path C2 between the second fluid tank 20 and the mixing tank 40 is formed in the tube assembly 30. Therefore, the control module 80 can turn on the pump 60, and control the pump 60 to transmit the second fluid in the second fluid tank 20 to the mixing tank 40 via the flow path C2.

As shown in FIG. 3C, the control module 80 turns on the third control valve 73 and the fourth control valve 74, and turns off the first control valve 71, the second control valve 72, and the fifth control valve 75, and thus a flow path C3 between the tube assembly 30 and the mixing tank 40 is formed in the tube assembly 30. Therefore, the control module 80 can turn on the pump 60, and control the pump 60 to transmit the fuel in mixing tank 40 via the flow path C3, and thus the fuel in the mixing tank 40 can be fully mixed.

As shown in FIG. 3D, the control module 80 turns on the fourth control valve 74 and the fifth control valve 75, and turns off the first control valve 71, the second control valve 72, and the third control valve 73, and thus a flow path C4 between the mixing tank 40 and the storage tank 50 is formed in the tube assembly 30. Therefore, the control module 80 can turn on the pump 60, control the pump 60 to transmit the fuel in the mixing tank 40 to the storage tank 50 via the flow path C4.

In some embodiments, the fuel mixing apparatus A10 does no include the storage tank 50, and the fifth pipe 35 is connected to the outlet 62 of the pump 60 and the reformer A20 (or the fuel cell stack A30). The control module 80 can turn on the pump 60, and control the pump 60 to transmit the fuel in the mixing tank 40 to the reformer A20 or the fuel cell stack A30 via the flow path C4.

Therefore, in this embodiment, only one pump 60 is needed to transmit the first fluid, the second fluid or fuel, and the manufacturing cost of the fuel mixing apparatus A10 can be decreased.

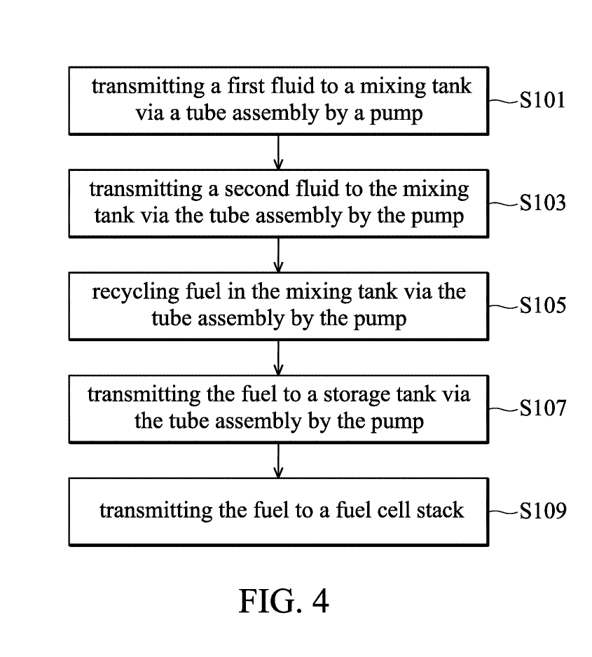

FIG. 4 is a flow chart of the fuel mixing-and-transmitting method for the fuel cell system A1 in accordance with some embodiments of the present disclosure. In step S101, the detection module 90 detects the height of the liquid level of the fuel in the mixing tank 40. When the height of the liquid level of the fuel is equal to or lower than a height H1 of a replenishing-liquid level (as shown in FIG. 3A), the detection module 90 transmits a replenishing signal to the control module 80. The height H1 of the replenishing-liquid level is measured in a vertical direction D1, which is perpendicular to a horizontal plane. Afterwards, as shown in FIG. 3A, the control module 80 controls the pump 60 and the control valves 70 to the flow path C1 formed in the tube assembly 30 according to the replenishing signal. The pump 60 transmits the first fluid in the first fluid tank 10 to the mixing tank 40 via the flow path C1.

As shown in FIG. 3A, the detection module 90 includes a liquid-level detector 91 and a temperature sensor 92. In this embodiment, the liquid-level detector 91 is a liquid-level switch. The liquid-level detector 91 is disposed in the mixing tank 40, and electrically connected to the control module 80. When the liquid level S1 of the fuel is lower than the liquid-level detector 91 (in other words, the height of liquid level of the fuel is equal to or lower than the height H1 of the replenishing-liquid level), the liquid-level detector 91 generates a replenishing signal to control module 80.

The temperature sensor 92 is mounted on the tube assembly 30, and electrically connected to the control module 80. In this embodiment, the temperature sensor 92 is mounted on the third pipe 33. When the first fluid is transmitted to the mixing tank 40 via the tube assembly 30, the temperature sensor 92 detects the temperature of the first fluid, and generates a first temperature signal. The control module 80 controls the volume of the first fluid in the first fluid tank 10 transmitted to the mixing tank 40 via the tube assembly 30 by the pump 60 according to the first temperature signal.

Since the pump 60 is a quantitative pump in this embodiment, the volume of liquid outputted by the pump 60 each time is accurately defined. For example, the output of the pump 60 is each time per 10 seconds, and the volume of the output of the pump each time is 1 liter. The control module 80 controls the number of times the output is performed, or the time during which the pump 60 is in operation according to the operation settings, and thus the control module 80 can calculate the volume of first fluid in the first fluid tank 10 transmitted to the mixing tank 40 via the tube assembly 30 and by the pump 60. For example, the control module 80 controls the pump 60 to operate 60 times, or for 600 seconds, according to the operation settings, and thus 600 liters of the first fluid is accurately transmitted to the mixing tank 40.

Moreover, using the temperature of the first fluid detected by the temperature sensor 92 and the volume of the first fluid being input into the mixing tank 40, the control module 80 can calculate the weight of the first fluid transmitted to the mixing tank 40 via the tube assembly 30 by the pump 60.

After the pump 60 is operated a predetermined number of times, or operated for a predetermined period of time, the control module 80 controls the pump 60 and the control valves 70 to stop transmitting the first fluid to the mixing tank 40. Afterwards, in the S103, the control module 80 controls the pump 60 and the control valves 70 to form the flow path C2 in the tube assembly 30, and controls the pump 60 to transmit the second fluid in the second fluid tank 20 to the mixing tank 40 via the flow path C2.

In this embodiment, the weight of the second fluid being input into the mixing tank 40 and the weight of the first fluid being input into the mixing tank 40 in step S101 comply with the predetermined weight ratio. Therefore, when the second fluid is transmitted to the mixing tank 40 via the tube assembly 30, the temperature sensor 92 detects the temperature of the second fluid and generates a second temperature signal. The control module 80 can control the weight of the second fluid in the second fluid tank 20 transmitted to mixing tank 40 by the pump 60 according to the second temperature signal.

In this embodiment, the control module 80 calculates the weight of the second fluid that needs to be transmitted into the mixing tank 40 according to the weight of the first fluid being input into the mixing tank 40 and the predetermined weight ratio. Afterwards, the control module 80 calculates the volume of the second fluid that needs to be transmitted into the mixing tank 40 according to the weight of the second fluid that needs to be transmitted into the mixing tank 40 and the second temperature signal. Finally, the control module 80 calculates the number of output times or the operating time of the pump 60 according to the volume of the second fluid that needs to input into the mixing tank 40. Therefore, the volume of second fluid being input into the mixing tank 40 can be accurately controlled by the control module 80.

Therefore, using this mixture method, the weight ratio of the first fluid and the second fluid being input into the mixing tank 40 can be accurately controlled. The operating efficiency of the fuel mixing apparatus A10 is improved, and the maintenance time of the fuel mixing apparatus A10 is decreased.

After the control module 80 controls the pump 60 to operate in a predetermined output times or operating time, the control module 80 controls the pump 60 and the control valves 70 to stop transmitting the second fluid to the mixing tank 40. In step S105, the control module 80 controls the pump 60 and the control valves 70 to form the flow path C3 in the tube assembly 30, and the fuel in the mixing tank 40 can be recycle via the flow path C3 by the pump 60. Therefore, the fuel in the mixing tank 40 can be mixed well.

After a predetermined time, such as 10 minutes, the control module 80 controls the pump 60 and the control valves 70 to stop recycling the fuel in the mixing tank 40 via the flow path C3. In step S107, when the fuel in the storage tank 50 is lower than a liquid-level detector 93 of the detection module 90, the liquid-level detector 93 generates a replenishing signal to the control module 80. The control module 80 controls the pump 60 and the control valves 70 according to the replenishing signal to form the flow path C4 in the tube assembly 30. Moreover, the control module 80 controls the pump 60 to transmit the fuel in the storage tank 50 via the flow path C4.

In step S109, the fuel in the storage tank 50 is transmitted to the reformer A20 or the fuel cell stack A30. In this embodiment, the fuel in the storage tank 50 is transmitted to the reformer A20. The reformer A20 reforms the fuel, and transmits the reformed fuel to the fuel cell stack A30. Finally, the fuel processes chemical reactions in the fuel cell stack A30, and the fuel cell stack A30 generates electric power. The water (or the second fluid) generated by the fuel cell stack A30 is transmitted to the second fluid tank 20 by the condenser A40. Therefore, the water (or the second fluid) can be recycled and reused.

In this embodiment, during the liquid level S1 of the fuel in the mixing tank 40 descending, the control module 80 shall not transmit the first fluid or the second fluid to the mixing tank 40 until the liquid level S1 is equal to or lower than the height H1 of the replenishing-liquid level (or lower than the liquid-level detector 91).

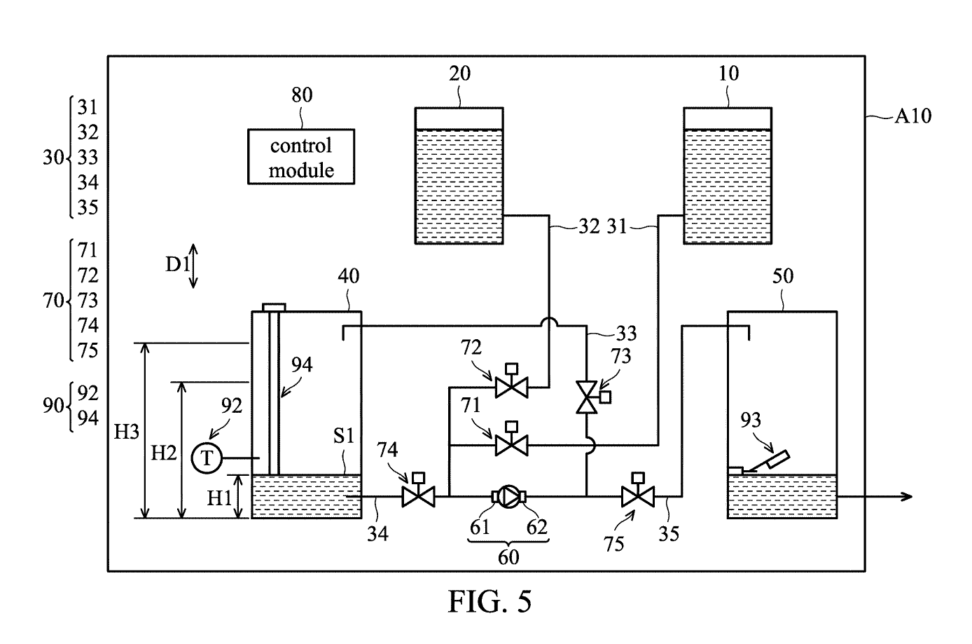

FIG. 5 is a system diagram of the fuel mixing apparatus A10 in accordance with a second embodiment of the present disclosure. In this embodiment, the detection module 90 includes a temperature sensor 92 and a continuous liquid-level transmitter 94. The temperature sensor 92 and the continuous liquid-level transmitter 94 are electrically connected to the control module 80. The temperature sensor 92 is disposed in the mixing tank 40, and configured to detect the temperature of the first fluid or the fuel in the mixing tank 40.

The continuous liquid-level transmitter 94 is disposed in the mixing tank 40, and configured to detect the height of the liquid level of the fuel (or the first fluid) in the mixing tank 40. The continuous liquid-level transmitter 94 continuously transmits liquid-level signals corresponding to the height of the liquid level.

In step S101, the continuous liquid-level transmitter 94 detects the liquid level S1 of the fuel in the mixing tank 40 is lower than or equal to the height H1 of the replenishing-liquid level, the continuous liquid-level transmitter 94 generates a replenishing signal to the control module 80. The control module 80 controls the pump 60 and the control valves 70 to form the flow path C1 in the tube assembly 30 according to the replenishing signal, and controls the pump 60 to transmit the first fluid in the first fluid tank 10 to the mixing tank 40 via the flow path C1.

When the continuous liquid-level transmitter 94 detects the height of the liquid level of the first fluid or the fuel in the mixing tank 40 to arrive a height H2 of a first predetermined liquid level, the continuous liquid-level transmitter 94 transmits a first liquid-level signal. The control module 80 controls the pump 60 and the control valve 70 to stop transmitting the first fluid to the mixing tank 40. Moreover, the control module 80 controls the pump 60 transmits the second fluid of the second fluid tank 20 to the mixing tank 40 via the tube assembly 30 (in step S103).

The control module 80 calculates the volume of the first fluid that needs to be transmitted to the mixing tank 40 according to the height H1 of the replenishing-liquid level and the height H2 of the first predetermined liquid level. In this embodiment, after the first fluid is transmitted to the mixing tank 40 via the tube assembly 30, the temperature sensor 92 detects the temperature of the first fluid, and generates a first temperature signal. Therefore, the control module 80 can calculate the weight of the first fluid being input into the mixing tank 40 according to the volume of the first fluid inputted in the mixing tank 40 and the first temperature signal.

Afterwards, the control module 80 calculates the weight of the second fluid that needs to be transmitted into the mixing tank 40 according to the predetermined weight ratio and the weight of the first fluid inputted into the mixing tank 40.

After the second fluid is transmitted to the mixing tank 40 via the tube assembly 30, the temperature sensor 92 generates a second temperature signal. In this embodiment, the control module 80 obtains the volume of the second fluid that needs to be transmitted to the mixing tank 40 according to the second temperature signal and the weight of the second fluid that needs to be transmitted to the mixing tank 40. Finally, the control module 80 sets a height H3 of a second predetermined liquid level according to the volume of the second fluid that needs to be transmitted to the mixing tank 40 and the height H2 of the first predetermined liquid level.

When the height of the liquid level of the fuel arrives to the height H3 of the second predetermined liquid level, the control module 80 controls the pump 60 to stop transmitting the second fluid to the mixing tank 40.

Using this mixture method, the weight ratio of the first fluid and the second fluid transmitted to the mixing tank 40 can be accurately controlled. The operating efficiency of the fuel mixing apparatus A10 is improved, and the maintenance time of the fuel mixing apparatus A10 is decreased.

In this embodiment, during the liquid level S1 of the fuel descending, the control module 80 shall not transmit the first fluid or the second fluid to the mixing tank 40 until the liquid level S1 is lower than or equal to the height H1 of the replenishing-liquid level.

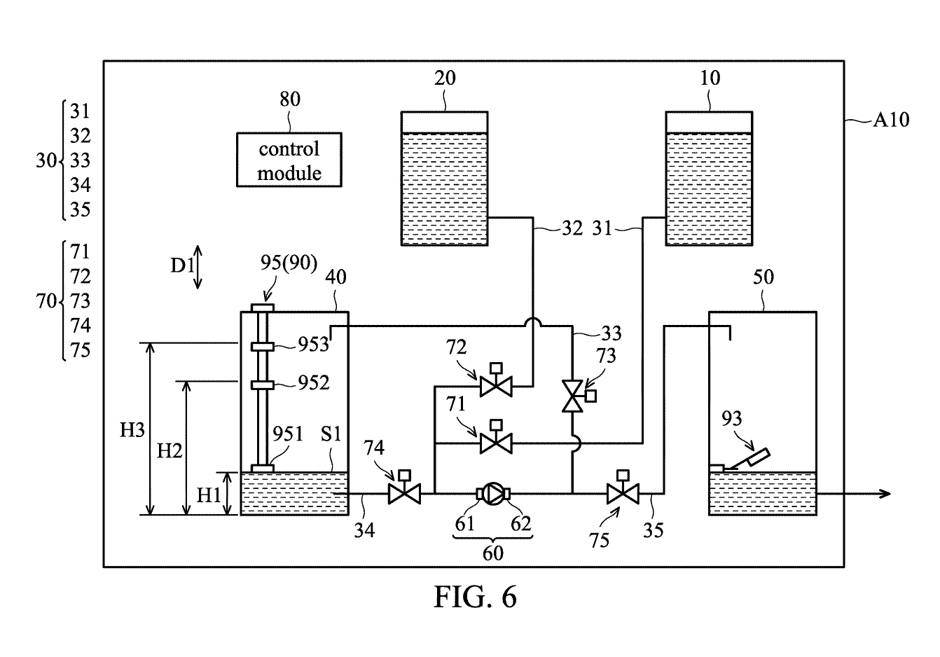

FIG. 6 is a system diagram of the fuel mixing apparatus A10 in accordance with a third embodiment of the present disclosure. In this embodiment, the detection module 90 includes a float level switch 95 disposed in the mixing tank 40. The float level switch 95 includes a first switch 951, a second switch 952, and a third switch 953.

In this embodiment, the first switch 951, the second switch 952, and the third switch 953 are arranged along the vertical direction D1, which is perpendicular to a horizontal plane. The first switch 951 is adjacent to the bottom of the mixing tank 40, and the third switch 953 is adjacent to the top of the mixing tank 40. The second switch 952 is located between the first switch 951 and the third switch 953.

In step S101, when the liquid level S1 of the fuel of the mixing tank 40 is lower than the first switch 951 (in other words, the height of the liquid level of the fuel is equal to or lower than the height H1 of the replenishing-liquid level) in the vertical direction D1, the control module 80 controls the pump 60 to transmit the first fluid in the first fluid tank 10 to the mixing tank 40 via tube assembly 30.

In step S103, when the liquid level S1 arrives to the second switch 952 in the vertical direction D1, the control module 80 controls the pump 60 and the control valves 70 to stop transmitting the first fluid to the mixing tank 40. Moreover, the control module 80 controls the pump 60 to transmit the second fluid in the second fluid tank 20 to the mixing tank 40 via the tube assembly 30.

When the fuel in the mixing tank 40 arrives to the third switch 953 in the vertical direction D1, the control module 80 controls the pump 60 to stop transmitting the second fluid to the mixing tank 40. Therefore, using this mixture method, the manufacturing cost of the fuel mixing apparatus A10 is decreased.

In this embodiment, during the liquid level S1 of the fuel descending, the control module 80 shall not transmit the first fluid or the second fluid into the mixing tank 40 until the liquid level S1 is lower than the first switch 951.

In conclusion, since the first fluid tank contains the first fluid, and the second fluid tank contains the second fluid, the first fluid needs to be refilled into the first fluid tank until the first fluid is insufficient. Therefore, the number of times of refilling the fuel to the fuel cell system is decreased. Moreover, the fuel is formed by automatically mixing the first fluid and the second fluid in the fuel cell system. Therefore, the maintenance cost of the fuel cell system is decreased.

Moreover, the present disclosure utilizes only one pump to individually transmit the first fluid in the first fluid tank and the second fluid in the second fluid tank to the mixing tank. Therefore, the maintenance cost of the fuel mixing apparatus is further decreased.

The disclosed features may be combined, modified, or replaced in any suitable manner in one or more disclosed embodiments, but are not limited to any particular embodiments.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel mixing apparatus for fuel cell system, comprising:
a first fluid tank configured to contain a first fluid;
a second fluid tank configured to contain a second fluid;
a tube assembly connected to the first fluid tank and the second fluid tank;
a pump mounted on the tube assembly;
a mixing tank connected to the tube assembly;
wherein the pump transmits the first fluid in the first fluid tank to the mixing tank via the tube assembly, and the pump transmits the second fluid in the second fluid tank to the mixing tank via the tube assembly,
wherein the first fluid and the second fluid are mixed to be a fuel in the mixing tank.

2. The fuel mixing apparatus as claimed in claim 1, further comprising a storage tank connected to the tube assembly, wherein the pump transmits the fuel in the mixing tank to the storage tank via the tube assembly.

3. The fuel mixing apparatus as claimed in claim 1, further comprising:
a plurality of control valves mounted on the tube assembly; and
a control module configured to respectively control the control valves and the pump to turn on or off;
wherein when the control module controls the control valves to form a first flow path in the tube assembly, the pump transmits the first fluid in the first fluid tank to the mixing tank via the first flow path,
wherein when the control module controls the control valves to form a second flow path in the tube assembly, the pump transmits the second fluid in the second fluid tank to the mixing tank via the second flow path.

4. The fuel mixing apparatus as claimed in claim 3, further comprising a storage tank connected to the tube assembly, wherein when the control module controls the control valves to form a third flow path in the tube assembly, the pump transmits the fuel in the mixing tank to the storage tank via the third flow path.

5. The fuel mixing apparatus as claimed in claim 1, further comprising:
a temperature sensor mounted on the tube assembly;
a plurality of control valves mounted on the tube assembly; and
a control module configured to respectively control the control valves and the pump to turn on or off;
wherein when the first fluid is transmitted to the mixing tank via the tube assembly, the temperature sensor detects a temperature of the first fluid and generates a first temperature signal, and the control module controls a volume of the first fluid in the first fluid tank transmitted to the mixing tank via the tube assembly according to the first temperature signal,
wherein when the second fluid is transmitted to the mixing tank via the tube assembly, the temperature sensor detects a temperature of the second fluid and generates a second temperature signal, and the control module controls a volume of the second fluid in the second fluid tank transmitted to the mixing tank via the tube assembly according to the second temperature signal.

6. The fuel mixing apparatus as claimed in claim 1, further comprising:
a temperature sensor, disposed in the mixing tank, configured to detect a temperature of the first fluid or the fuel in the mixing tank;
a continuous liquid-level transmitter, disposed in the mixing tank, configured to detect a height of a liquid level of the first fluid or the fuel in the mixing tank;
a plurality of control valves mounted on the tube assembly; and
a control module configured to respectively control the control valves and the pump to turn on or off;
wherein after the first fluid is transmitted to the mixing tank via the tube assembly, the temperature sensor generates a first temperature signal, and when the continuous liquid-level transmitter detects the height of the liquid level of the first fluid or the fuel in the mixing tank arriving to a height of a predetermined liquid level, the control module controls the pump to transmit the second fluid in the second fluid tank to the mixing tank via the tube assembly,
wherein after the second fluid is transmitted to the mixing tank via the tube assembly, the temperature sensor generates a second temperature signal, and the control module sets a height of a second predetermined liquid level according to the second temperature signal,
wherein when the height of the liquid level of the fuel is to the height of the second predetermined liquid level, the control module controls the pump to stop transmitting the second fluid to the mixing tank.

7. The fuel mixing apparatus as claimed in claim 1, further comprising:
a float level switch, disposed on in the mixing tank, comprising a first switch, a second switch, and a third switch;
a plurality of control valves mounted on the tube assembly; and
a control module configured to respectively control the control valves and the pump to turn on or off;
wherein when a liquid level of the fuel in the mixing tank is lower than the first switch in a vertical direction, the control module controls the pump to transmit the first fluid in the first fluid tank to the mixing tank via the tube assembly,
wherein when the liquid level arrives to the second switch in the vertical direction, the control module controls the pump to transmit the second fluid in the second fluid tank to the mixing tank via the tube assembly, and when the fuel in the mixing tank arrives to the third switch in the vertical direction, the control module controls the pump to stop transmitting the second fluid to the mixing tank.

8. A fuel cell system, comprising the fuel mixing apparatus as claimed in claim 1, further comprising:
a fuel cell stack, coupled to the fuel mixing apparatus, configured to generate electric power.

9. The fuel cell system as claimed in claim 8, further comprising a reformer configured to receive the fuel from the fuel mixing apparatus, and transmit the fuel to the fuel cell stack after reforming the fuel.

10. The fuel cell system as claimed in claim 9, wherein the fuel transmitted to the reformer from the fuel mixing apparatus is a liquid fuel, and the liquid fuel is reformed to a gas fuel by the reformer.

11. The fuel cell system as claimed in claim 8, further comprising a condenser coupled to the fuel cell stack and the second fluid tank, wherein the fuel cell stack further generates water, and the condenser collects the water generated by the fuel cell stack, and transmits the water to the second fluid tank.

12. A fuel mixing-and-transmitting method for fuel cell system, comprising:
detecting a height of a liquid level of the fuel in a mixing tank;
transmitting a first fluid in a first fluid tank to a mixing tank via a tube assembly and by a pump, when the height of the liquid level is equal to or lower than a height of a replenishing-liquid level; and
transmitting a second fluid in a second fluid tank to the mixing tank via the tube assembly by the pump, wherein the first fluid and the second fluid are mixed to be a fuel in the mixing tank.

13. The fuel mixing-and-transmitting method as claimed in claim 12, further comprising: recycling the fuel in the mixing tank via the tube assembly by the pump.

14. The fuel mixing-and-transmitting method as claimed in claim 12, further comprising: transmitting the fuel to a storage tank via the tube assembly by the pump.
